(19) United States
(12) Patent Application Publication
(10) Pub. No.: US 2011/0030620 A1
(43) Pub. Date: Feb. 10, 2011

(54) ACCESSORY FOR SUCTION DEVICE PROVIDED WITH COMB AND HAIR-CLEARING MEMBER, AND SUCTION ASSEMBLY INCLUDING THE SAME

(75) Inventor: Herve Jouan, Nantes (FR)

Correspondence Address: YOUNG & THOMPSON, 209 Madison Street, Suite 500, Alexandria, VA, 22314, US

(73) Assignee: NOVADIF, Breal Sous Montfort (FR)

(21) Appl. No.: 12/937,854

(22) PCT Filed: Mar. 31, 2009
(86) PCT No.: PCT/FR09/50540

§ 371 Date: Oct. 14, 2010

(30) Foreign Application Priority Data
Apr. 15, 2008 (FR) 0802058

(51) Int. Cl. A01K 13/00

(52) U.S. Cl. 119/611

(57) ABSTRACT

An accessory (1) for a suction device (2) includes a hollow body forming a suction head (10) provided with a nozzle (11) connecting to the suction device, the head including a mouthpiece opening (3), the accessory also including a comb (4) disposed inside the suction head as well as a hair-clearing member (6). The comb is pivotally mounted between one so-called active end position, in which the teeth of the comb project from the mouthpiece opening, and an inactive end position, in which the teeth of the comb are retracted into the suction head, the clearing member being pivotally mounted inside the suction head, and the accessory including an actuating mechanism that pivots the comb, and which is distinct from the clearing member. A suction assembly including such an accessory is also described.

### BACKGROUND OF THE INVENTION

The present invention relates in general terms to accessories for suction devices.

The invention relates more specifically to an accessory for a suction device, intended particularly for animal grooming, said accessory comprising a hollow body forming a suction head with a connection end for connecting the accessory directly or indirectly to said suction device, said head comprising an inlet opening and said accessory also comprising on the one hand a comb housed inside the suction head and provided with at least one row of teeth, and on the other hand a hair removing member acting on the comb to remove residual hairs.

### DESCRIPTION OF THE PRIOR ART

Document DE102004028609 discloses a cleaning accessory comprising a cylindrical brush with teeth that act on a perforated ring. When the accessory is in use, the brush rotates upon itself. The brush forms a comb that has a plurality of rows of teeth set out circumferentially and housed in the perforations in the ring, the axis of the ring being off center with respect to the axis of rotation of the brush in such a way that when the teeth of the brush are rotated relative to the perforated ring, hairs caught between the teeth of the brush are removed radially. However, this cylindrical brush and hair removing member occupy a great deal of space inside the suction head, which reduces the cross section available for suction both at the front of the suction head and at the rear. “Front” of the suction head means the upstream part of the head in the direction of suction, while the rear of the suction head corresponds to the downstream part of the head in the suction direction. The use of a brush also makes it difficult to remove long hairs.

Moreover, whatever the position of rotation of the comb, some teeth project out of the inlet opening, which exposes them to damage.

### SUMMARY OF THE INVENTION

In general terms it is an object of the present invention to improve the operation of grooming an animal by limiting the number of residual hairs left on the animal's coat after passing the accessory over it, and improving the removal of hairs caught in the comb.

One object of the present invention is to limit the size of both the comb and the hair removing member inside the suction head.

Another object of the invention is to enable suction in the upstream area of the inlet opening, in the suction direction, in other words between the front part of the suction head and the comb.

A particular object of the invention is to have an unobstructed passage between the assembly formed by the comb and the hair removing member and the top wall of the suction head, in order to facilitate suction towards the front of the suction head.

Another object of the invention is to allow the teeth of the comb to be retracted inside the head when the accessory is not in use.

To this end, the invention relates to an accessory for a suction device, intended particularly for animal grooming, said accessory comprising a hollow body forming a suction head with a connection end for connecting the accessory directly or indirectly to said suction device, said head comprising an inlet opening and said accessory also comprising on the one hand a comb housed inside the suction head and provided with at least one row of teeth, and on the other hand a hair removing member acting on the teeth of the comb to remove residual hairs, the comb being able to pivot between an end position called the active position, in which the teeth of the comb project from the inlet opening, and an end position called the inactive position, in which the teeth of the comb are retracted into the suction head,

wherein said hair removing member is able to pivot inside the suction head and is arranged with respect to said comb in such a way that pivoting the comb causes the hair removing member to pivot,
and wherein said accessory comprises a mechanism, connected to said comb, for causing the comb to pivot.

The actuating mechanism is separate from the hair removing member and the hair removing member is passive in the sense that it only pivots when the comb is moved. The expression “hair removing member” is used to mean any member capable of removing hairs caught on the comb, especially on the teeth of the comb, to facilitate their removal by suction.

The hair removing member may be a combtooth wiper designed to slide between the teeth of the comb to remove hairs stuck between the teeth of the comb. The hair removing member may also be formed by a scraper capable of scraping one face of the teeth of the comb. In addition, the comb may be a conventional grooming comb or a so-called thinning comb with cutting teeth which are shorter than those of a conventional comb. In the case of a thinning comb, the hair removing member used is a scraper.

The fact that the actuating mechanism is connected to the comb makes it possible to reduce the size, and therefore the space requirements, of the hair removing member. This is because the hair removing member is pivoted directly and progressively by the rotational movement of the comb, so the part of the removing member which provides the pivotal connection to the suction head receives only small forces. Such a design of the accessory thus limits the obstacles to the suction flow in the so-called upper area of the suction head—that is, the area situated above the axis of rotation of the comb. The result is improved suction from the upstream area (also called the front area) of the inlet.

If (this is not what happens in the invention) the pivoting of the comb/hair-removing-member assembly occurred through the hair removing member connected directly to the actuating means, the hair removing member would be subjected to greater forces and would therefore have to be engineered to have sufficient mechanical strength to withstand these forces, which would increase the size of the hair removing member. Increasing the size of the hair removing member in this way would create an obstacle inside the suction head, particularly in the upper area of the suction head, which would reduce or even prevent suction from the upstream (or front) area of the inlet. To allow suction from the upstream area of the inlet opening—that is, from the front of the head—the passage above the axis of rotation of the comb must be unobstructed.

The fact that, in the solution of the invention, the comb is pivoted by the actuating means does not mean that the mechanical strength of the comb has to be increased, because said comb is already designed to be strong enough not to break when grooming animals. Consequently, owing to the solution according to the invention, it is unnecessary to increase the size of the comb, and the size of the hair removing member can be reduced. This in turn frees up space in the upper area of the suction head, i.e. above the axis of rotation of the comb. As explained above, freeing up space above the comb allows suction from the front part of the inlet opening towards the connection end via the upper area of the head. Clearly, suction upstream of the inlet opening cannot take place through the lower area of the head because the latter area is occupied by the comb in the active position.

Such a design of the accessory thus makes it possible to generate large suction flows on either side of the comb, i.e. from the upstream and downstream areas of the inlet opening. This improves the efficiency of the grooming operation. In particular, fewer hairs are left on the animal's coat after the accessory has been passed over it.

What is more, the possibility of actuating the comb between its two end positions means that, when the accessory is not in use, the comb can be returned to its retracted (inactive) position inside the head, thus protecting the comb teeth from damage.

Unlike the device of the prior art document DE102004028609, there is no need with the accessory according to the invention to distribute teeth on both sides of the axis of rotation of the comb because it is always the same teeth which work the animal's coat when the accessory is being used. One row of teeth is therefore sufficient.

The angle through which the comb and hair removing member pivot is preferably chosen to be between 110° and 150°. Said angle of pivoting is advantageously about 130°. The assembly consisting of the comb and the hair removing assembly does not therefore obstruct the suction passage in the upper area of the suction head, even when the comb is retracted. The passageway for suction above the pivot axis of the comb is thus never obstructed.

In accordance with an advantageous feature of the invention, in the inactive position the teeth of the comb point towards the connection end.

Since the axis of the connection end corresponds to the direction of the suction flow, the comb points, in the inactive position, approximately parallel to the suction flow. This facilitates the suction removal of hairs still present on the comb and on the hair removing member.

In accordance with an advantageous feature of the invention, the hair removing member is a combtooth wiper formed by a member, such as a plate, having a row of orifices through which the teeth of the comb pass, the pivot axis of the combtooth wiper being oriented parallel to and at a distance from the pivot axis of the comb, to allow the combtooth wiper to slide along the teeth of the comb.

Such a design of the combtooth wiper allows the comb to pivot the combtooth wiper easily during its movement from the active position to the inactive position and back again. In particular, the axis of rotation of the combtooth wiper is, firstly, between the axis of rotation of the comb and the connection end, and, secondly, at a distance from the axis of rotation of the comb in such a way that when the comb is in the active position the combtooth wiper is positioned near the base of the teeth of the comb, and when it is in the inactive position the combtooth wiper is moved towards the ends of the teeth. Such a configuration of the comb and combtooth wiper enables the combtooth wiper to remove hairs from the complete circumference of the comb teeth when the comb moves from the active position to the inactive.

In accordance with an advantageous feature of the invention, the hair removing member is formed by a scraper, the pivot axis of which is oriented parallel to and at a distance from the pivot axis of the comb to allow said scraper to scrape one face of the teeth of the comb when said comb is pivoted.

In accordance with an advantageous feature of the invention, said actuating mechanism is formed by at least one and preferably two inextensible and deformable cord(s) connected on the one hand to the comb and on the other hand to a member for tensioning the or each cord.

When the cord or cords is/are tensioned, the assembly consisting of the comb and the removing member is caused to pivot. The use of a deformable cord allows said cord to follow a non-linear path when displaced as a result of being tensioned. Thus, when, in order to pivot the comb and the hair removing member, the cord is forced to move along a curved portion of its path, its flexibility allows it to easily follow said curved portion of its path. The operator can thus pivot the comb and the hair removing member reliably.

The use of at least one deformable cord also means that said cord or each cord can be run along the walls of the suction head, so that the cord does not obstruct the suction passage between the inlet opening and the connection end. In other words, it is possible to arrange for at least a portion of said or each cord to run along the inside face of the wall of the suction head, either in contact with or near to said inside face, so as not to obstruct the passage of the suction flow from the inlet opening to the connection end. With the accessory according to the invention, therefore, the congestion inside the suction head is reduced, which increases the suction capacity of the accessory. The efficiency of the grooming operation is thus improved.

The use of two separate cords allows more reliable pivoting of the comb.

In accordance with an advantageous feature of the invention, the connection end, which is elongate, forms a handle that allows the user to hold the accessory in one hand, and the tensioning member is situated on the handle in such a way that it can be actuated by the fingers of the hand when the hand is holding the accessory, said tensioning member preferably being located under the handle, the underside of the handle corresponding to that part of the handle which is on the same side as the inlet opening with respect to the center line of the connection end.

By means of such an arrangement of the tensioning member, the operator, who is holding the accessory in one hand by the connection end, can pivot the comb with this same hand: by simply squeezing his or her fingers, the user can actuate the tensioning member, such as a trigger, which thus applies a pulling force to the or each cord and so pivots the comb into the active position. This feature is preferred to a button-lever system for actuating the axis of rotation which could be envisaged positioned on the suction head, close to the axis of rotation of the comb, because the user would have to use his or her other hand to operate the button-lever. This would be difficult in practice.

In accordance with an advantageous feature of the invention, the tensioning member of said or each cord is formed by a trigger comprising a part that can be moved between an extreme squeezed position towards the handle, in which said or each cord is tensioned so that a pulling force acts on the corresponding cord to cause the comb to pivot and thus move the teeth of the comb into the active position, and an extreme open position away from the handle, in which each cord is relaxed to allow the comb to move into the inactive position.

In accordance with an advantageous feature of the invention, when the teeth of the comb are in the active position, said teeth are inclined relative to the normal to the plane of the inlet of the head, said teeth pointing towards the upstream part of the suction head, along the suction direction.

In accordance with an advantageous feature of the invention, the comb is provided with a return member, such as a spring, to return said comb to the inactive position.

The invention also relates to a suction assembly, intended particularly for animal grooming, comprising an accessory for a suction device as described above and a hair collector, said hair collector having an orifice for connection to said accessory and another orifice for connection to the suction device, so as to be connected in series between the accessory and the suction device.

### BRIEF DESCRIPTION OF THE DRAWINGS

A clear understanding of the invention will be gained from reading the following description of certain illustrative embodiments, with reference to the appended drawings, in which:

FIG. 1 is a view of the grooming assembly comprising a suction device, a collector and an accessory according to the invention in a first embodiment where the hair removing member is a combtooth wiper;

FIG. 2 is a perspective view of the accessory from FIG. 1 with the comb in the active position;

FIG. 3 is a perspective view of the accessory from FIG. 1 with the comb in the half-folded position;

FIG. 4 is a perspective view of the accessory from FIG. 1 with the comb in the inactive position;

FIG. 4a is a detail view of part of the accessory from FIG. 4 showing a cord for pivoting the comb;

FIG. 5 is a partial exploded view of the accessory;

FIG. 6 is a detail view of a variant of the cord tensioning member;

FIG. 7 is a cross section through the area marked VII in FIG. 5 showing the cord guide means;

FIG. 8a is an axial cross section through the accessory from FIG. 1 showing the path of the cords from the comb to the trigger, with the trigger in the relaxed position;

FIG. 8b is an axial cross section through the accessory from FIG. 1 with the trigger in the actuated position;

FIG. 8c is a detailed view of part of the head of the accessory from FIG. 8a;

FIG. 9a is a perspective view of another embodiment of the accessory according to the invention, said accessory being provided with a thinning comb and a scraper, the comb being in the active position;

FIG. 9b is a view of the accessory from FIG. 9a with the comb in the half-folded position; and

FIG. 9c is a view of the accessory from FIG. 9a with the comb in the inactive position.

### DESCRIPTION OF THE PREFERRED EMBODIMENTS

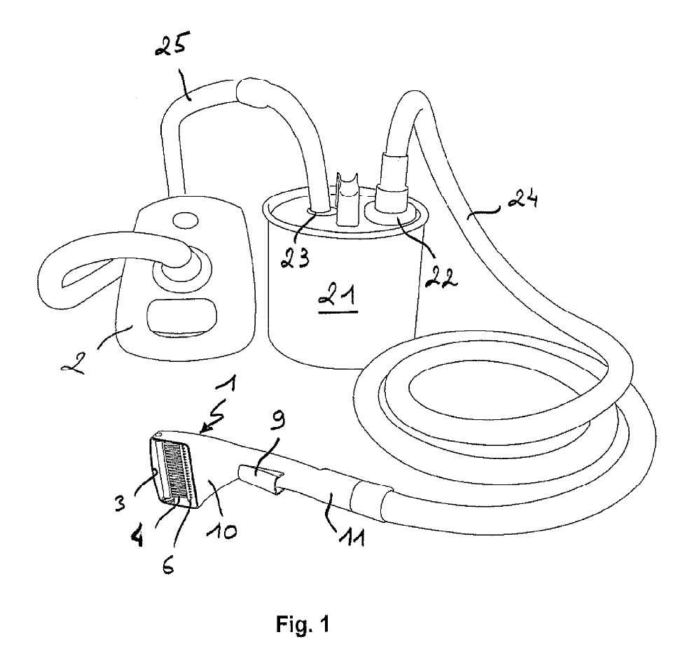

FIG. 1 shows a suction assembly, intended particularly for animal grooming, comprising a suction device 2 and an accessory 1, with a hair collector 21 in the middle. Said hair collector 21 comprises an orifice 22 for connection to said accessory 1 and another orifice 23 for connection to the suction device 2 thus connecting it in series between the accessory 1 and the suction device 2. Said accessory is connected to the collector 21 by a hose 24 of sufficient length, preferably from 5 m to 6 m, so that the suction device 2, and, optionally, the collector, can be placed in one room while the suction accessory 1 is placed in another room with the animal, so as not to frighten it when the suction device is on. The collector 21 can be connected to the suction device 2 by a hose 25 which may be shorter.

Said accessory 1 comprises a hollow body forming a suction head 10 with a connection end 11 for directly or indirectly connecting the accessory 1 to said suction device 2. Said head 10 also has an inlet opening 3 designed to be placed against the coat of the animal to be groomed. The connection end is of course hollow and communicates with the interior of the suction head to allow suction via the inlet opening.

Said accessory 1 also comprises on the one hand a comb housed inside the suction head 10 and provided with at least one row of teeth, and on the other a hair removing member which acts on the teeth of the comb to remove residual hairs.

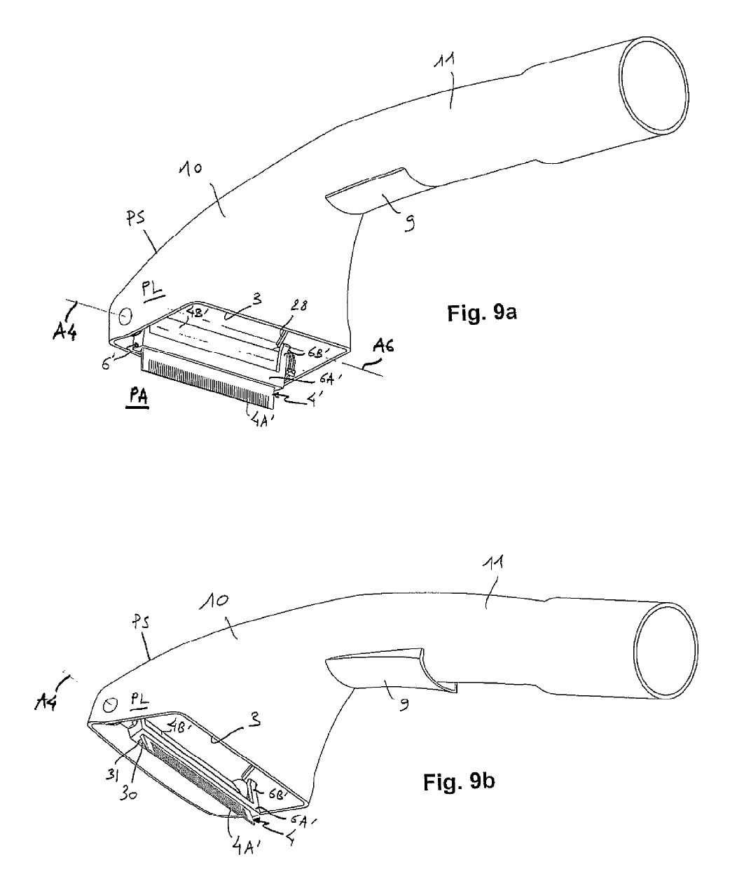

In a first embodiment illustrated in FIGS. 1-8c, the comb is a conventional grooming comb 4 and the removing member is a combtooth wiper 6 that acts on the teeth of the comb 4 to remove hairs that have become stuck between and/or around the comb teeth 4A. In particular, the combtooth wiper comprises parts engaged between the teeth 4A of the comb 4 to remove the hairs. As described later, in a second embodiment illustrated in FIGS. 9a, 9b and 9c, the hair removing member is a scraper designed to scrape at least one face of the teeth of a thinning comb.

In the first embodiment shown in FIGS. 1-8c, the comb is able to pivot between an end position called the active position PA, in which the teeth 4A of the comb 4 project from the inlet opening 3, and an end position called the inactive position PI, in which the teeth 4A of the comb 4 are retracted into the suction head 10. The combtooth wiper 6 is able to pivot inside the suction head 10 and is arranged in relation to said comb 4 in such a way that when the comb 4 pivots, it causes the combtooth wiper 6 to pivot also. It is a feature of said accessory 1 that it also comprises a mechanism, connected to the comb 4, for causing pivoting of said comb 4. This actuating mechanism is separate from the combtooth wiper 6. Said combtooth wiper 6 can thus be pivoted only by pivoting the comb 4.

The connection end 11 of the suction head 10 is in the upper area of said suction head—that is, above the axis of rotation of the comb. By convention, in this application, the term “upper” will be used for the part of the accessory which is on the opposite side of the axis A4 of rotation of the comb 4 from the inlet opening 3. The lower part of the accessory is thus the part which faces the animal's coat. By convention also, the term “front” of the suction head means the upstream part of the head in the direction of suction, the term “rear” of the suction head corresponding to the downstream part of the head in the direction of suction. The upstream part AM of the inlet opening also means the part of the inlet situated in front of the axis of rotation of the comb with reference to the position of the connection end. The upstream part AM of the inlet opening also corresponds to the part of the inlet opening situated upstream in the projection of the direction of the suction flow in the plane of the inlet opening. Likewise the downstream part AV of the inlet opening is defined as the part of the inlet situated to the rear of the axis of rotation of the comb with reference to the position of the connection end. The downstream part AV of the inlet opening also corresponds to the part of the inlet opening situated downstream in the projection of the direction of the suction flow in the plane of the inlet opening.

In the example illustrated in FIGS. 1-8c, the comb 4 is formed by a shaft 4B carrying a row of teeth 4A distributed along said shaft 4B and extending transversely relative to the axis A4 of said shaft 4B. Said shaft 4B pivots via its ends relative to the suction head 10.

The axis of rotation A4 of the comb 4 is oriented on the one hand transversely relative to the axis A11 of the connection end 11—that is, transversely relative to the suction flow—and on the other hand approximately parallel to the plane of the inlet opening 3. The ends of the shaft 4B of the comb 4 are thus connected pivotally to the side walls PL of the suction head 10. The side walls PL of the suction head are defined as those walls of the suction head 10 that are on either side of a plane of symmetry of the accessory passing through the axis A11 of the connection end 11 and orthogonal to the plane of the inlet opening 3.

The combtooth wiper 6 is formed by a member, such as a plate, a portion 6A of which has a row of holes through which the teeth 4A of the comb 4 pass. The pivot axis A6 of the combtooth wiper 6 is parallel to and at a distance from the pivot axis A4 of the comb 4, to enable the combtooth wiper 6 to slide along the teeth 4A of the comb 4. The pivot axes A4, A6 are arranged so that when the teeth 4A of the comb 4 are in the active position PA, the combtooth wiper 6 is close to the base of the teeth of the comb, and when the comb is in the inactive position PI, the combtooth wiper 6 is close to the free end of said teeth 4A. As illustrated in the figures, the axis A6 of rotation of the combtooth wiper 6 is located between the comb 4 and the connection end 11—that is, in the downstream (or rear) part of the suction head, viewed in the direction of suction, so that the upstream (or front) part of the suction head is not congested.

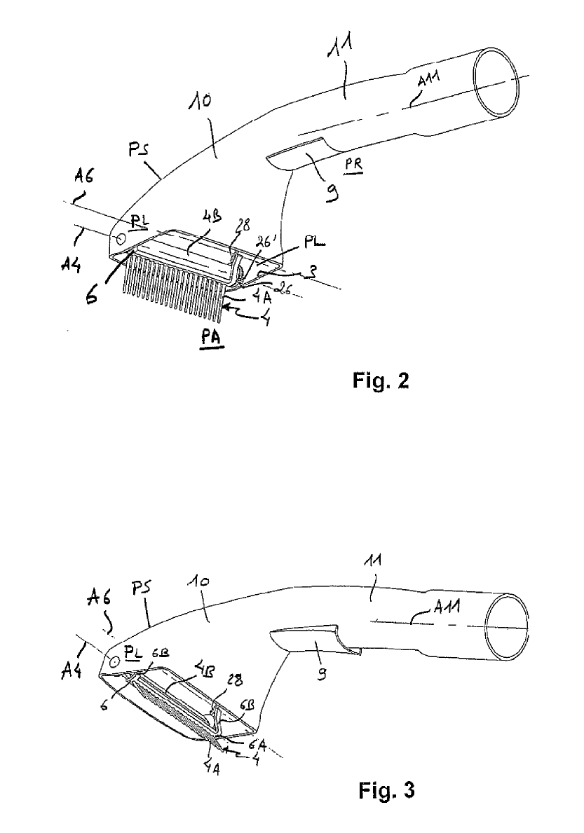

As illustrated more specifically in FIGS. 2-4, the perforated portion 6A of the combtooth wiper 6 extends approximately perpendicular to the plane of the teeth 4A of the comb when said comb and the combtooth wiper are acting on each other.

The axis of rotation A4 of the comb 4 is inside the suction head 10 at a sufficient distance from the upper wall PS (or top wall) of the suction head 10 to leave a suction passageway between the axis A4 of rotation of the comb 4 and the upper wall PS of the suction head 10. As noted above, the design of the accessory according to the invention improves the suction efficiency from the upstream area (or front) of the inlet opening, by limiting the congestion, especially the congestion generated by the combtooth wiper, in the upper space of the suction head defined as the space available between the axis A4 of rotation of the comb and the upper wall PS of the suction head. The reason for this is that the application of the actuating mechanism to the comb 4, rather than to the combtooth wiper 6, means that the size of the combtooth wiper 6 can be reduced, particularly at its pivot connection, thus reducing the congestion of the upper space in the suction head by the combtooth wiper 6. This design of the accessory thus ensures that the combtooth wiper 6, which is positioned between the comb 4 and the connection end 11, does not form an obstacle to the suction flow beginning in the upstream area AM of the inlet opening 3 and passing between the axis A4 of rotation of the comb and the upper wall PS of the head and out through the connection end 11. The accessory according to the invention therefore makes it possible to generate large suction flows on either side of the comb/combtooth wiper assembly—that is, from the upstream AM and downstream AV areas of the inlet opening.

Hence, in the example illustrated in FIGS. 1-8c, that part of the plate which extends between the axis A6 of rotation of the combtooth wiper 6 and the part 6A is a void. The void of the combtooth wiper 6 is such as to leave two side portions 6B forming two arms whose ends pivot freely inside the suction head 10 in such a way as to allow the combtooth wiper 6 to pivot when the comb 4 pivots. Such a void in the plate 6 allows the suction to pass through the axis A6 of rotation of the combtooth wiper. As explained above, this encourages suction from the upstream part AM of the inlet opening 3 to the connection end 11 via the upper space of the suction head.

The shaft 4B of the comb is preferably rectangular or square in general cross section. Compared with a conventional circular-section shaft with a diameter corresponding to the diagonal of the cross section of the shaft of the comb according to the invention, this uses less material for said shaft but still has sufficient mechanical strength for the forces involved. The size of the shaft of the comb according to the invention is thus also limited, freeing up a little more space for suction in the upper space of the suction head 10—that is, between the axis A4 of rotation of the comb 4 and the upper wall PS of the suction head 10—and therefore increasing the suction in the upstream part AM of the inlet opening 3.

Between its inactive position PI and its active position PA, the comb 4 pivots through an angle ALPHA of approximately between 110° and 150°, preferably about 130°. In the inactive position PI, the teeth 4A of the comb 4 point towards the connection end 11, that is in the same direction as the suction flow.

As shown in FIG. 1, the connection end 11 forms a handle allowing the user to handle the accessory 1 with just one hand. Preferably, as shown in the figures, the actuating mechanism comprises two separate deformable and inextensible cords 8, each connected at one end to the comb 4 and at the other end to a member 9 for tensioning each cord. In the example shown in the figures, each cord 8 is a nylon thread. Alternatively each cord may be a flexible metal rod—in other words inextensible but deformable in flexion.

The tensioning member 9 is positioned in the handle where it can be operated by the fingers of the hand when the hand is holding the accessory. Said tensioning member 9 is preferably located underneath the handle, meaning the part of the handle situated on the same side as the inlet opening with respect to the center line of the connection end.

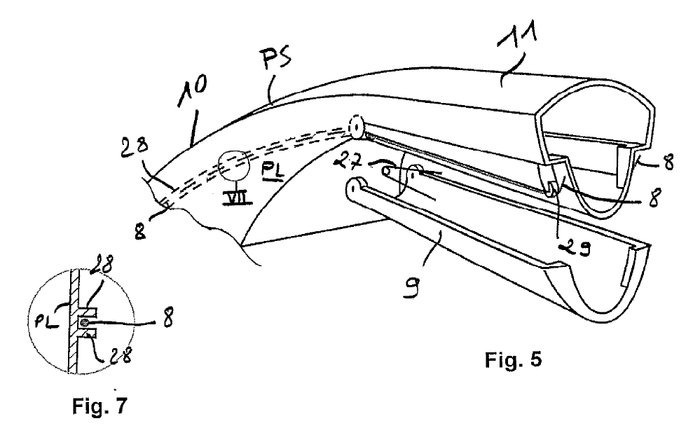

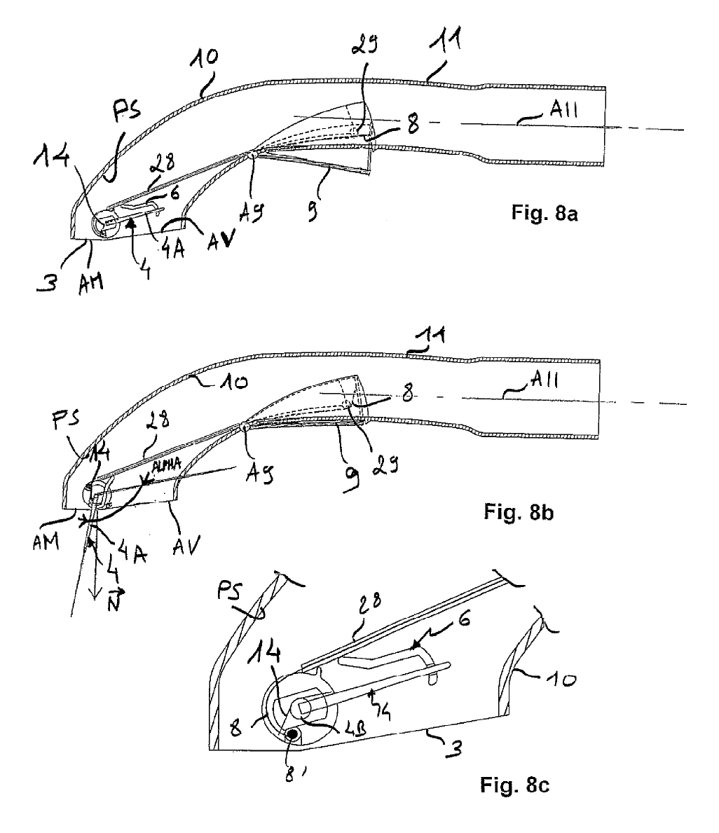

As illustrated more specifically in FIGS. 8a and 8b, the tensioning member of said cord or cords 8 is formed by a trigger 9 in the form of a tray mounted movably underneath the handle. When gripping the handle, the operator can at will press the trigger by squeezing his or her fingers around it. The trigger is moveable between an extreme squeezed position PR in which each cord 8 is tensioned, causing the comb 4 to pivot into the active position PA (FIG. 8a), and an extreme released position PE away from the handle 11 in which each cord 8 is released, allowing the comb 4 to swing into the inactive position PI (FIG. 8b). The trigger 9 pivots between its two extreme positions PI, PA about a pivot axis A9 at right angles to the axis A11 of the connection end. A return spring 27 returns the trigger to the released position away from the handle (FIG. 5).

As shown in FIG. 8b, when the trigger is pressed, each cord 8 is pulled and guided by a pulley wheel 29, which may either be fixed or pivot freely, thereby applying a tensile load to the corresponding cord 8 to pivot the shaft 4B of the comb and thus move the teeth 4A of the comb into the active position.

As shown in FIGS. 8a, 8b and 8c, a return spring 14 returns the comb to the inactive position PI inside the suction head. When the accessory 1 is moved by the user across the animal's coat, in a direction proceeding from the head towards the handle, the hairs exert frictional forces on the teeth of the comb which help to keep the teeth of the comb projecting from the inlet opening. There is therefore no need to apply strong pressure to the trigger to keep the comb in the active position.

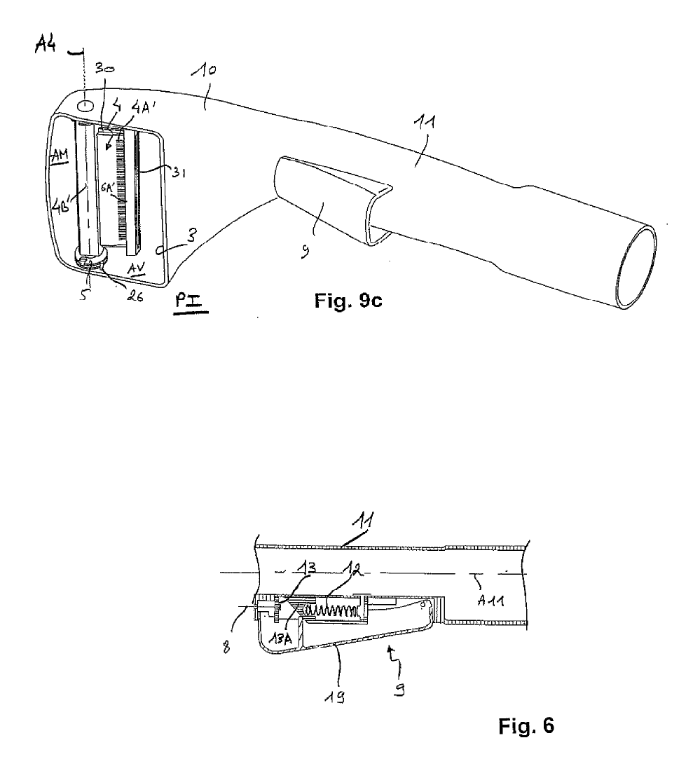

In an alternative embodiment of the trigger, the pulley wheel can be omitted. Thus, in the example shown in FIG. 6, the trigger is formed by a pivoting piece 19 which when squeezed pushes against a ramp 13A of a motion transmission member 13 to which one end of each cord 8 is attached. Said motion transmission member 13 slides between two positions, an end position in which the cord is taut and an end position in which the cord is relaxed. A spring 12 draws said member back to this cord-relaxed position. The pressure on the trigger, acting through the ramp 13A, causes the member 13 to move to the position of cord tension and spring 12 compression. Thus, when the trigger is released, the spring 12 returns the member 13 to the cord-relaxed position, and the movement of the ramp 13A of the member 13 swings the trigger back away from the handle.

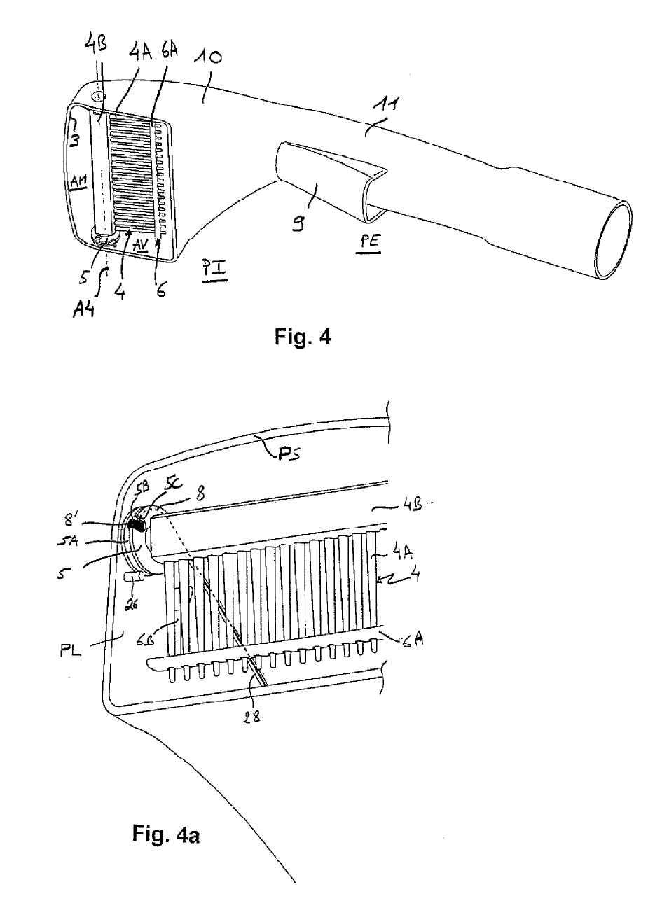

As shown more specifically in FIGS. 4a, 5 and 7, the head 10 of the accessory comprises means for guiding each cord 8 along the side walls PL of the head, on the inside of said head. For each cord 8 the guide means are formed by two parallel ribs 28 running along the side walls PL of the suction head from near the trigger 9 to near the comb 4. In this way each cord, whether actually touching or just near a side wall PL, essentially follows the profile of said side wall, and so does not congest the suction space defined by the body of the head. Hair suction is thus facilitated. The cord guide ribs 28 moreover also form for said cords a protective barrier against passing hairs. The channel defined by the two ribs may optionally be capped to protect the cords.

As illustrated in FIG. 5, in the area of the accessory corresponding to the connection end, the cords 8 pass out of the head 10 and enter the trigger 9—that is, in the example shown in the figures, between the tray defining the trigger and the bottom wall of the connection end. This arrangement of the cords between the tray of the trigger and the connection end saves having the cords enter the connection end. As a result, in the area of the accessory corresponding to the connection end, the cords pass underneath the connection end and therefore do not obstruct the suction flow. Said cords are thus also protected from passing residual hairs in this area of the accessory.

In the example illustrated in the figures, each end of each cord 8 has a cylindrical crimped ferrule 8′, which is attached to a part 5 of the shaft 4B of the comb 4. Said part 5 is preferably made in one piece with the rest of the shaft. As shown in FIGS. 4 and 4a, each cord 8 attachment part 5 is formed by a disk of a certain thickness with a groove 5A around its periphery in which an end portion of the cord, fitted with said ferrule 8′, is laid. This peripheral groove 5A guides the corresponding cord 8 when the shaft 4B of the comb is pivoted. The sides of the peripheral groove 5A include openings 5B, 5C to house the cord 8 attachment ferrule 8′. Said openings for housing the attachment ferrule are formed by an opening 5B in one side of the groove and by another through-opening 5C in the opposite side of the groove. This opening 5C also runs out radially with respect to the axis of the disk so that the ferrule 8′ can be inserted in said openings.

As illustrated in FIG. 4a, each cord is secured to the corresponding part 5 of the shaft, on the one hand on the far side from the teeth of the comb with respect to a plane passing through the axis A4 of rotation of the comb 4 and orthogonal to the teeth 4A of the comb, and on the other hand close to the periphery of the disk so that the cord securing location is eccentric with respect to the pivot axis A4 of the shaft 4B. Each cord 8 is consequently attached to an area of the shaft remote from the axis A4 of rotation such that when the cords 8 are tensioned the teeth 4A of the comb 4 are pivoted into the active position.

As illustrated more specifically in FIG. 8b, when the teeth 4A of the comb 4 are in the active position, they are inclined with respect to the normal N to the plane of the inlet 3 of the head 10, said teeth pointing towards the upstream (or front) part AM of the suction head 10. Such a configuration of the comb teeth makes the accessory more ergonomical and thus more easily handled by the operator who usually holds the connection end at a certain angle of inclination with respect to the animal's coat. Consequently, when the accessory is held at an angle, the teeth of the comb are approximately vertical with respect to the area of the coat that is being groomed, thus improving the efficiency and comfort of the grooming operation.

During the transition from the inactive position PI to the active position PA of the comb, the pivoting movement of the comb is limited by a stop 26 with which a part 26′ of the comb, in this case a pin, comes into contact to prevent the comb from pivoting further than its active position in the clockwise direction.

The upper wall of the head is preferably transparent, at least over the comb, so that the user can see the part of the coat being groomed.

In a second embodiment of the accessory illustrated in FIGS. 9a, 9b and 9c, the comb is a thinning comb 4′ and the hair removing member is a scraper 6′. The description of the accessory given above, for the first embodiment illustrated in FIGS. 1-8c, applies to this second embodiment, which is a variant of the first, the comb 4 being replaced by the thinning comb 4′ and the combtooth wiper 6 by the scraper 6′.

In this second embodiment, the thinning comb 4′ has a rotary shaft 4B′ mounted pivotally inside the suction head 10 and having teeth 4A′. The teeth 4A′ of the thinning comb differ from those of the comb 4 in that they comprise cutting parts and are closely spaced. The length of said teeth 4A′ of the thinning comb is also shorter. As an example, the teeth 4A of the comb 4 (FIGS. 1-8c) are preferably between 20 mm and 30 mm in length and are separated by a distance of preferably between 1 mm and 4 mm. The teeth 4A′ of the thinning comb 4′ are separated by a distance of preferably between 0.5 mm and 1.5 mm, and are preferably between 0.4 mm and 10 mm in length.

The scraper 6′ comprises a so-called active part 6A′ held by arms 6B′ which pivot inside the suction head 10 in a similar way to the combtooth wiper 6 in the first embodiment shown in FIGS. 1-8c. The active part 6A′ of the scraper is formed by a parallelepiped-shaped body containing a central through-slot 31. The thinning comb 4′ sits inside the slot 31 of the scraper. The shape of the slot 31 corresponds approximately to the shape of the cross section of the comb 4′, the cross section of the comb corresponding to a section in a plane orthogonal to the plane of the comb 4′ and parallel to the pivot axis of said comb 4′. An inside face of the scraper formed by a side wall of the slot 31 is thus in firm contact with one face of the teeth 4A′ of the thinning comb 4′, so that when the comb 4′ is pivoted from the active position to the inactive position of said comb, the teeth of the comb are scraped from their base to their end, in such a way as to remove any hairs stuck between and/or around them. What happens is that, as shown in FIGS. 9a, 9b and 9c, the scraper 6′ is able to pivot, in a similar way to the combtooth wiper 6, between one end position, corresponding to the comb-active position, in which the active part of the scraper is on the base of the teeth of the comb, and another end position, corresponding to the comb-inactive position, in which the active part of the scraper is near the ends of said teeth.

In the example shown in the figures, that face of the comb teeth which is scraped by the scraper corresponds to that face of the teeth which is on the downstream side of the inlet opening 3 of the accessory head 10 when the comb is in the active position.

As shown more specifically in FIGS. 9b and 9c, the cross section of the comb diminishes from the base of the comb towards the end of the teeth of said comb. Therefore, to limit the play of the comb 4′ in the slot 31 of the scraper 6′ as the thinning comb 4′ moves from the active to the inactive position, means are provided to guide the scraper 6′ with respect to the comb 4′. These guide means are formed by grooves 30 running along the side edges of the thinning comb 4′ that engage with the internal side edges of the scraper body, these internal side edges of the scraper body being complementary in shape to said grooves 30. The use of such guide means limits the relative movement between the comb 4′ and the scraper 6′ in a direction orthogonal to the plane of said thinning comb 4′.

1. An accessory for a suction device, intended particularly for animal grooming, said accessory comprising a hollow body forming a suction head with a connection end for connecting the accessory directly or indirectly to said suction device, said head comprising an inlet opening and said accessory also comprising on the one hand a comb housed inside the suction head and provided with at least one row of teeth, and on the other hand a hair removing member acting on the teeth of the comb to remove residual hairs, the comb being able to pivot between an end position called the active position, in which the teeth of the comb project from the inlet opening, and an end position called the inactive position, in which the teeth of the comb are retracted into the suction head,
wherein said hair removing member is able to pivot inside the suction head and is arranged with respect to said comb in such a way that pivoting the comb causes the hair removing member to pivot,
and wherein said accessory comprises a mechanism, connected to said comb, for causing the comb to pivot.

2. The accessory as claimed in claim 1, wherein the hair removing member is a combtooth wiper formed by a member, such as a plate, having a row of orifices through which the teeth of the comb pass, the pivot axis of the combtooth wiper being oriented parallel to and at a distance from the pivot axis of the comb, to allow the combtooth wiper to slide along the teeth of the comb.

3. The accessory as claimed in claim 1, wherein the hair removing member is formed by a scraper, the pivot axis of which is oriented parallel to and at a distance from the pivot axis of the comb to allow said scraper to scrape one face of the teeth of the comb when said comb is pivoted.

4. The accessory as claimed in claim 1, wherein in the inactive position the teeth of the comb point towards the connection end.

5. The accessory as claimed in claim 1, wherein said actuating mechanism is formed by at least one and preferably two inextensible and deformable cord(s) connected on the one hand to the comb and on the other hand to a member for tensioning the or each cord.

6. The accessory as claimed in claim 5, wherein the connection end, which is elongate, forms a handle that allows the user to hold the accessory in one hand, and the tensioning member is situated on the handle in such a way that it can be actuated by the fingers of the hand when the hand is holding the accessory, said tensioning member preferably being located under the handle, the underside of the handle corresponding to that part of the handle which is on the same side as the inlet opening with respect to the center line of the connection end.

7. The accessory as claimed in claim 5, wherein the tensioning member of said or each cord is formed by a trigger comprising a part that can be moved between an extreme squeezed position towards the handle, in which said or each cord is tensioned so that a pulling force acts on the corresponding cord to cause the comb to pivot and thus move the teeth of the comb into the active position, and an extreme open position away from the handle, in which each cord is relaxed to allow the comb to move into the inactive position.

8. The accessory as claimed in claim 1, wherein the comb is provided with a return member, such as a spring, to return said comb to the inactive position.

9. The accessory as claimed in claim 1, wherein when the teeth of the comb are in the active position, said teeth are inclined relative to the normal to the plane of the inlet of the head, said teeth pointing towards the upstream part of the suction head, along the suction direction.

10. A suction assembly, intended particularly for animal grooming, comprising an accessory for a suction device as claimed in claim 1, and a hair collector, said hair collector having an orifice for connection to said accessory and another orifice for connection to the suction device, so as to be connected in series between the accessory and the suction device.

11. The accessory as claimed in claim 2, wherein in the inactive position the teeth of the comb point towards the connection end.

12. The accessory as claimed in claim 2, wherein said actuating mechanism is formed by at least one and preferably two inextensible and deformable cord(s) connected on the one hand to the comb and on the other hand to a member for tensioning the or each cord.

13. The accessory as claimed in claim 6, wherein the tensioning member of said or each cord is formed by a trigger comprising a part that can be moved between an extreme squeezed position towards the handle, in which said or each cord is tensioned so that a pulling force acts on the corresponding cord to cause the comb to pivot and thus move the teeth of the comb into the active position, and an extreme open position away from the handle, in which each cord is relaxed to allow the comb to move into the inactive position.
